(19) United States
(12) Patent Application Publication
(10) Pub. No.: US 2006/0262079 A1
(43) Pub. Date: Nov. 23, 2006

(54) Backlight unit and liquid crystal display employing the same

(75) Inventors: Ki-bum Seong, Anyang-si (KR); Tae-hee Cho, Seoul (KR); Jong-min Wang, Seongnam-si (KR); Jin-kyoung Oh, Seoul (KR); Su-gun Kim, Hwaseong-si (KR); Il-yong Jung, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/436,533

(22) Filed: May 19, 2006

(30) Foreign Application Priority Data
May 19, 2005 (KR) 10-2005-0042184

(51) Int. Cl. G09G 3/36

(52) U.S. Cl. 345/102

(57) ABSTRACT

A backlight unit and an LCD employing the backlight unit are provided. The backlight unit includes: a plurality of division areas; a light source which is able to be lighted and is disposed on one sidewall surface of a barrier rib defining the plurality of division areas; and a heat radiation device disposed on an opposite wall surface of the barrier rib to the one sidewall surface, wherein each of the plurality of division areas is constructed to bi-divide light reflection and heat radiation.

### CROSS-REFERENCE TO RELATED PATENT APPLICATION

This application claims priority from Korean Patent Application No. 10-2005-0042184, filed on May 19, 2005, in the Korean Intellectual Property Office, the disclosure of which is incorporated herein in its entirety by reference.

### BACKGROUND OF THE INVENTION

1. Field of the Invention

The present invention relates to a backlight unit and a liquid crystal display employing the same and, more particularly, to a backlight unit that can perform heat radiation and sequential division lighting, and a liquid crystal display employing the same.

2. Description of the Related Art

A liquid crystal display (LCD), which is a type of flat panel display, is a light receiving type display that is not self-luminescent but forms an image using incident light from an outside source. A backlight unit is disposed at a rear of the LCD to irradiate light toward a liquid crystal panel.

A cold cathode fluorescence lamp (CCFL) is generally used as a light source of the backlight unit of the LCD. However, the CCFL has a comparatively short lifetime and a low color reproducibility. The CCFL is much more disadvantageous with respect to lifetime and color reproducibility than a light emitting diode (LED) and is also more disadvantageous in instant lighting than an LED.

Since the CCFL is poor at instant lighting, it is difficult to employ a backlight unit using the CCFL as a light source in a time-division LCD. The time-division LCD requires a backlight unit that can be division lighted to synchronize with a picture scan time. A backlight unit using an LED as a light source can satisfy such a requirement.

The backlight units are generally classified, depending on the arrangement of light source, into direct light type backlight units in which light emitted from a plurality of light sources disposed right below a liquid crystal panel is irradiated toward the liquid crystal panel, and edge light type backlight units in which light emitted from a light source disposed on a sidewall of a light guide panel is transmitted to a liquid crystal panel.

The direct light type backlight units may use, for example, an LED as a point light source. In the direct type backlight unit using the LED as a point light source, LEDs are arranged in a two-dimensional array. Especially, the LEDs are arranged in plural lines, each line having a plurality of LEDs arranged in a line.

FIG. 1 shows a sectional view of a conventional direct light type backlight unit having a plurality of LEDs arranged in plural lines. Referring to FIG. 1, the conventional direct light type backlight unit includes a plurality of LEDs 1 mounted in a line on a metal core printed circuit board (MCPCB) 3, a plurality of heat radiation fins 5 disposed on a lower surface of the MCPCB 3, and a diffusion plate 7 for diffusing and transmitting the light diverging from the LEDs 1 to irradiate the diffused and transmitted light toward a liquid crystal panel (not shown).

The LEDs generate much heat. As the temperature of the backlight unit increases due to the generated heat, the amount and wavelength of light diverging from the LEDs are varied, so that brightness and color coordinate of the backlight unit are varied. The heat radiation fins 5 are used to radiate the heat generated from the heat source, such as the LEDs 1, and are mounted outside the backlight unit.

The heat generated from the LEDs 1 is transmitted through the MCPCB 3 effective in heat conduction and is then radiated to the outside. A fan (not shown) may be provided so as to radiate heat more easily through the heat radiation fins 5.

However, since the heat radiation fins 5 of the conventional direct light type backlight unit occupy much space, it is difficult to effectively arrange an image board or a power board for an LCD employing the backlight unit.

Meanwhile, the conventional direct light type backlight unit using the LEDs as a light source can be used in a time-division LCD. In the time-division LCD, the LEDs 1 are divided in area depending on their turning on or off and the area-divided LEDs are lighted in synchronization with a scan time of the liquid crystal panel.

However, since the conventional direct light type backlight unit fails to prevent light diverging from a selected one of the divided areas from invading an adjacent area, it is difficult to effectively remove the motion blur phenomenon in that an after-image remains when an image frame is changed to another one.

### SUMMARY OF THE INVENTION

An apparatus consistent with the present invention relates to a backlight unit having an improved structure such that a heat radiation device is installed inside, decreasing an overall thickness of a system employing the same.

Also, the present invention provides a backlight unit to prevent light from being leaked toward an adjacent division area as the backlight is sequentially division-lighted in synchronization with a screen scanning time of an LCD, and an LCD employing the backlight unit.

According to an aspect of the present invention, there is provided a backlight unit including: a plurality of division areas; a light source which is operative to be lighted and is disposed on one sidewall surface of at least one barrier rib defining the plurality of division areas; and a heat radiation device disposed on an opposite wall surface of the at least one barrier rib to the one sidewall surface, wherein each of the plurality of division areas is constructed to bi-divide light reflection and heat radiation.

According to another aspect of the present invention, there is provided a backlight unit including: a plurality of barrier ribs spaced apart from one another to form a plurality of division areas; a plurality of light sources which are disposed on the one sidewall surface of each of the plurality of barrier ribs and are operative to be instantly lighted; a heat radiation device disposed at a rear of each of the plurality of barrier ribs to radiate heat generated from the plurality of light sources disposed on the one sidewall surfaces of the plurality of barrier ribs; a reflection member disposed inclined to each of the plurality of barrier ribs to reflect light emitting from the plurality of light sources; and a diffusion plate disposed over the plurality of barrier ribs to diffuse and transmit incident light.

The heat radiation device may include at least one heat radiation fin.

The light source may be one of a light emitting diode (LED) and an organic light emitting diode (OLED).

The plurality of light sources disposed on each of the plurality of barrier ribs may be arranged so as to form a line.

The plurality of light sources disposed on each of the plurality of barrier ribs may include three kinds of light sources respectively emitting red, green and blue lights and mixed with one another so as to emit white light, or each of the plurality of light sources is a multi-chip light source emitting red, green and blue lights.

The plurality of light sources belonging to the respective plurality of division areas are sequentially lighted in a group of the division areas at a predetermined time interval.

Each of the plurality of barrier ribs may be provided with an MCPCB.

According to another aspect of the present invention, there is provided an LCD including a liquid crystal panel and a backlight unit disposed at a rear of the liquid crystal panel to irradiate light toward the liquid crystal panel wherein the backlight unit includes the elements of the above backlight unit.

The plurality of light sources belonging to the respective plurality of division areas may be sequentially lighted in a group of the division areas in synchronization with a screen scanning time of the liquid crystal panel.

### BRIEF DESCRIPTION OF THE DRAWINGS

The above and other features and advantages of the present invention will become more apparent by describing in detail exemplary embodiments thereof with reference to the attached drawings, in which:

FIG. 1 is a schematic sectional view of a conventional direct light type backlight unit provided with a plurality of LEDs arranged in a line;

FIG. 2 is a perspective view partially showing a backlight unit according to an exemplary embodiment of the present invention;

FIG. 3 is a detailed view of a selected portion of FIG. 2;

FIG. 4 is a schematic view of an LCD provided with a backlight unit according to the present invention;

FIG. 5A is a schematic view exemplarily showing a division lighting operation method of a light source in a backlight unit according to the present invention; and

FIG. 5B is a schematic view exemplarily showing a division lighting state of a light source in a backlight unit according to the present invention.

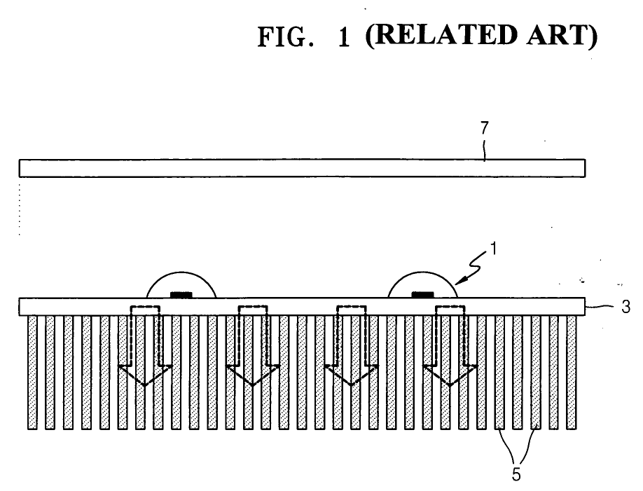

### DETAILED DESCRIPTION OF ILLUSTRATIVE, NON-LIMITING EMBODIMENTS OF THE INVENTION

The present invention will now be described more fully with reference to the accompanying drawings, in which exemplary embodiments of the invention are shown.

In a backlight unit according to the present invention, a heat radiation structure is placed inside the backlight unit. Also, the backlight unit has a structure that while being used as a light source for an LCD, the backlight unit has N-number of division areas so as to be sequentially lighted in synchronization with a scanning time of a liquid crystal panel, a light source, for example, an LED, is positioned between barrier ribs defining the division areas, a heat radiation device, for example, a heat radiation fin, is attached on an opposite wall surface of the barrier ribs, and one division area bi-divides light reflection and heat radiation.

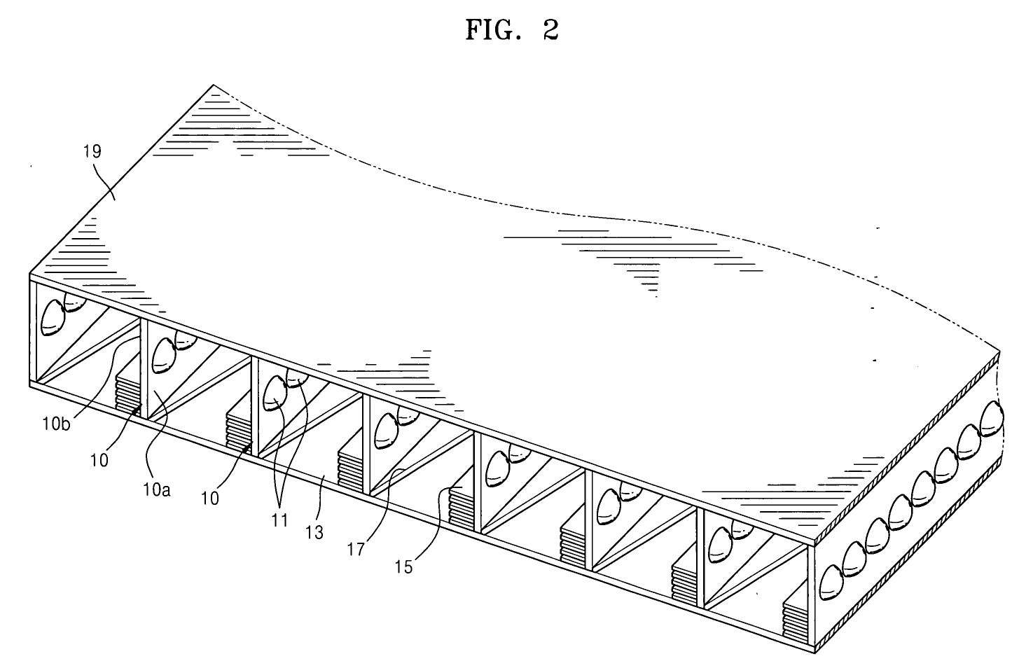

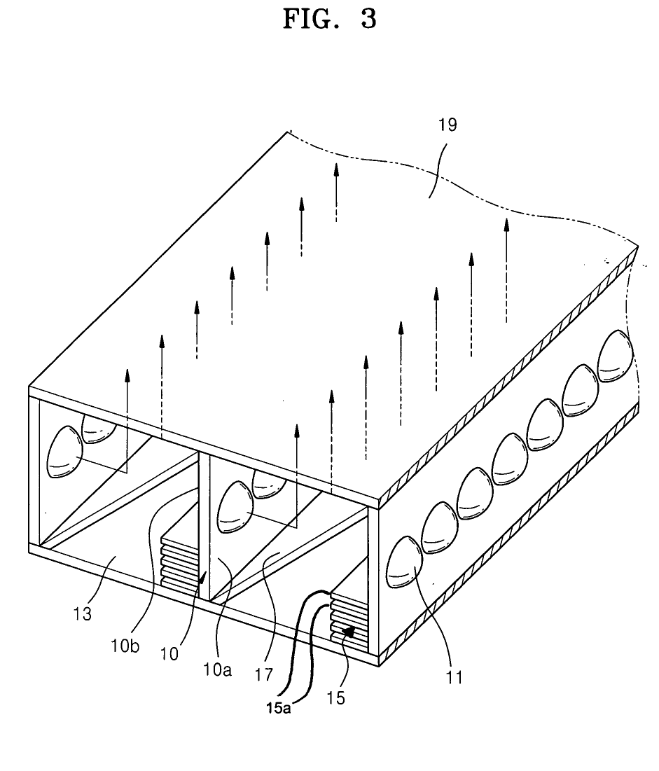

FIG. 2 is a perspective view partially showing a backlight unit according to an exemplary embodiment of the present invention, and FIG. 3 is a detailed view of a selected portion of FIG. 2.

Referring to FIGS. 2 and 3, the backlight unit consistent with the present invention includes a plurality of barrier ribs 10 spaced apart from one another so as to form a plurality of division areas each having a predetermined width and line shape, a plurality of light sources 11 which are disposed on one sidewall surface 1 0a of each of the plurality of barrier ribs 10 and are able to be instantly lighted, a heat radiation device 15 disposed at a rear of each of the plurality of barrier ribs 10, a reflection member 17 disposed inclined to each of the plurality of barrier ribs 10, and a diffusion plate 19 disposed on the plurality of barrier ribs 10 to diffuse and transmit incident light. In FIGS. 2 and 3, a base 13 is positioned beneath the plurality of barrier ribs 10. Of course, the backlight unit may be configured without the base 13.

The plurality of light sources 11 are disposed on the one sidewall surface 10a of each of the plurality of barrier ribs 10. At this point, the plurality of light sources 11 may be arranged so as to form a single line on the one sidewall surface 10a of each of the plurality of barrier ribs 10. Also, the plurality of light sources 11 may be arranged so as to form plural lines on the one sidewall surface 10a of each of the plurality of barrier ribs 10 or to have an approximately uniform distribution.

Each of the plurality of barrier ribs 10 is preferably, but not necessarily, a metal core printed circuit board (MCPCB) on which the plurality of light sources 11 disposed on the one sidewall surface 10a of each of the plurality of barrier ribs 10 are electrically connected. By doing so, heat generated from the plurality of light sources 11, for example, LEDs can be more effectively transmitted to the heat radiation device 15 positioned at a rear of the barrier ribs 10. Alternatively, the plurality of light sources 11 may be mounted on a separate PCB, which is attached on the one sidewall surface 10a of each of the plurality of barrier ribs 10.

The number of the division lighting areas can be determined according to the number of the barrier ribs where the light sources are disposed. For example, when it is intended to divide the backlight unit into N-number of areas and selectively light the divided N-number of areas, it is preferable, but not necessary, that the number of the barrier ribs where the light sources are disposed be at least N-number.

As the light sources 11, for example, a luminous element such as an organic light emitting diode (OLED) or a light emitting diode (LED) that can be instantly lighted to output diverging light can be used.

Compared with the linear light source using a CCFL, the point light source 11 using the OLED or LED is more advantageous in color reproducibility, lifetime and the like. Especially, since the point light source can be instantly lighted, it is possible that the point light source flickers in synchronization with a scanning time of an LCD.

The plurality of light sources 11 may be provided with a single luminous element chip generating a specific color light. In this case, it is preferable, but not necessary, that the plurality of light sources 11 arranged on each of the plurality of barrier ribs 10 be constructed such that three kinds of light sources respectively emitting red (R), green (G) and blue (B) lights are mixed to emit white light. Alternatively, each of the plurality of light sources 11 is provided with a multi-chip luminous element, for example, an RGB multi-chip LED, which is provided with at least one luminous element chip emitting red (R) light, at least one luminous element chip emitting green (G) light and at least one luminous element chip emitting blue (B) light, respectively.

Meanwhile, as shown in FIGS. 2 and 3, the light sources 11 have a dome-shaped cap structure, but the shape of the cap can be variously modified. Alternatively, the luminous element chips may be exposed without such caps.

The heat radiation device 15 is installed so as to induce forcible radiation of heat generated from the heat source including the light sources 11. The heat radiation device 15 may be provided with, for example, a heat radiation fins 15a.

The heat radiation fins 15a are installed at the other sidewall surface 10b of each of the plurality of barrier ribs 10 so as to radiate heat generated from the plurality of light sources 11 disposed on the one sidewall surface of each of the plurality of barrier ribs 10. Preferably, but not necessarily, the heat radiation fins 15a are, for example, connected to the other sidewall surface 10b (opposite to the one sidewall surface 10a on which the light sources 11 are disposed) to form a heat transmission path together with the barrier ribs 10, thereby effectively radiating the heat transmitted through the barrier ribs 10.

The heat radiation fins 15 are installed in a length direction of the barrier ribs 10 so as to correspond to the length of each of the barrier ribs, and are also installed corresponding to each of the barrier ribs. Since the heat radiation fms 15a are installed such that the fin portions thereof are approximately in parallel with the base 13 inside the backlight unit, the space for installation of the heat radiation fins 15a can be minimized. Accordingly, it becomes possible to decrease an overall thickness of the system.

It is preferable, but not necessary, that the heat radiation fins 15a is positioned at a space of which both sides of each fin are opened such that heat is effectively radiated to the outside. Heat radiation is performed in a direction in parallel with the barrier ribs 10.

Meanwhile, the reflection member 17 is provided for a bent light path, and it reflects the light emitting from the plurality of light sources and incident into the reflection member 17 such that the light progresses toward the diffusion plate 20. The reflection member 17 is made in the form of a reflection plate, and is disposed for uniform emission of light in an oblique direction of the division areas. One division area is made into a structure that bi-divides light reflection and heat radiation by the reflection member 17.

The diffusion plate 19 diffuses and transmits the light incident from the plurality of light sources 11 and the light reflected by the reflection member 17 and incident such that uniform light can be irradiated from the backlight unit, for example, to a liquid crystal panel.

In the backlight unit having the above construction according to an exemplary embodiment of the present invention, the plurality of barrier ribs 10 can be attached vertically on the diffusion plate 19. At this time, the plurality of light sources can be installed on the one sidewall surface 10a of each of the plurality of barrier ribs before or after the barrier ribs 10 are attached on the diffusion plate 19. Also, the heat radiation fins 15a may be installed after or before the barrier ribs 10 are attached on the diffusion plate 19. For example, the heat radiation fins 15a are first attached on the other sidewall surface 10b of each of the plurality of barrier ribs 10 and then the plurality of barrier ribs 10 are attached on the diffusion plate 19, or the plurality of barrier ribs 10 are first attached on the diffusion plate 19 and then the heat radiation fins 15a are attached on the other sidewall surface 10b of each of the plurality of barrier ribs 10.

Also, in the backlight unit having the above construction according to an exemplary embodiment of the present invention, the plurality of barrier ribs 10 may be attached vertically on the base 13. At this time, the plurality of light sources 11 can be installed on the one sidewall surface of each of the plurality of barrier ribs 10 before or after the barrier ribs 10 are attached on the base 13. Also, the heat radiation fins 15a may be installed after or before the barrier ribs 10 are attached on the base 13. For example, the heat radiation fins 15a are first attached on the other sidewall surface of each of the plurality of barrier ribs 10 and then the plurality of barrier ribs 10 are attached on the base 13, or the plurality of barrier ribs 10 are first attached on the base 13 and then the heat radiation fins 15a are attached on the other sidewall surface 10b of each of the plurality of barrier ribs 10.

In addition, when the backlight unit consistent with the present invention is constructed having the base 13, it is preferable, but not necessary, that the heat radiation fins 15a are connected with the plurality of barrier ribs 10 so as to be disposed on the base 13, thereby minimizing the influence of the weight of the heat radiation fins 15a on the plurality of barrier ribs 10.

In the backlight unit having the above construction according to an exemplary embodiment of the present invention, the light emitted from the light sources 11, for example, LEDs is reflected by the reflection member 17 inclined at an oblique angle and progresses in a vertical direction approximately. The light emitted from the light sources 11 and directly incident into the diffusion plate 19 or the light reflected by the reflection member 17 and then incident into the diffusion plate 19 transmits the diffusion plate 19 and is converted into an approximately uniform light.

Heat generated from the light sources 11 is radiated through the heat radiation fins 15a disposed on the other sidewall surface 10b of each of the plurality of barrier ribs 10 and is transferred to the outside by air circulating through a passage positioned below the reflection member 17.

The above backlight unit according to the present invention has the heat radiation device 15, for example, heat radiation fins 15a positioned at a space between the barrier ribs inside the backlight unit. Accordingly, since the backlight unit does not need a separate space for installation of the heat radiation fins 15a and the heat radiation fins 15a are installed approximately in parallel with the base 13, it is possible to decrease the overall thickness of the system.

In other words, since the backlight unit consistent with the present invention radiates heat utilizing an inner space thereof, there is no need for a heat radiation structure installed outside the system, which is required when the light sources 11, for example, LEDs are not arranged on the barrier ribs, but rather on a base member below the diffusion plate, resulting in the decrease in the overall thickness of the system.

Also, the backlight unit of the present invention is divided into N-number (N is an integer of 2 or more) of horizontal division areas by the plurality of barrier ribs 10 where the plurality of light sources 11 are disposed, so that light interference between adjacent division areas is prevented. Accordingly, the N-number of division areas can be sequentially lighted at a predetermined time interval without light interference between adjacent division areas.

Accordingly, the backlight unit consistent with the present invention can obtain the division lighting effect and heat radiation effect at the same time. Since the backlight unit according to the present invention has the heat radiation structure positioned inside the backlight unit, the overall thickness of the system is decreased compared with the conventional external heat radiation structure and the heat radiation can be effectively performed. Also, by using the backlight unit consistent with the present invention, a sequential lighting operation of the N-number of division areas is possible and light interference between adjacent division areas during the scanning time of the LCD is eliminated, thereby removing an image display error due to the light interference.

While the above embodiments show and describe examples that the backlight unit according to the present invention is provided with the heat radiation fins 15a as the heat radiation device, other various embodiments for the heat radiation device 15 will be possible. For example, the heat radiation device 15 may have the heat radiation fins 15a and further a heat pipe. Also, the heat radiation device 15 may have only a heat pipe instead of the heat radiation fins 15a. As well known to those skilled in the art, the heat pipe includes an evaporation part, an adiabatic part and a condensation part. When heat is applied to the evaporation part, working fluid is evaporated and transferred to the condensation part via the adiabatic part, and the evaporated working fluid that is liquefied in the condensation part returns to the evaporation part through a wick. By repeating these processes, heat from the heat source, for example, heat generated from the light sources 11 and the like is transmitted to the outside, thereby providing a cooling effect. Thus, the heat pipe has a cooling effect by transferring heat using a circulation of working fluid.

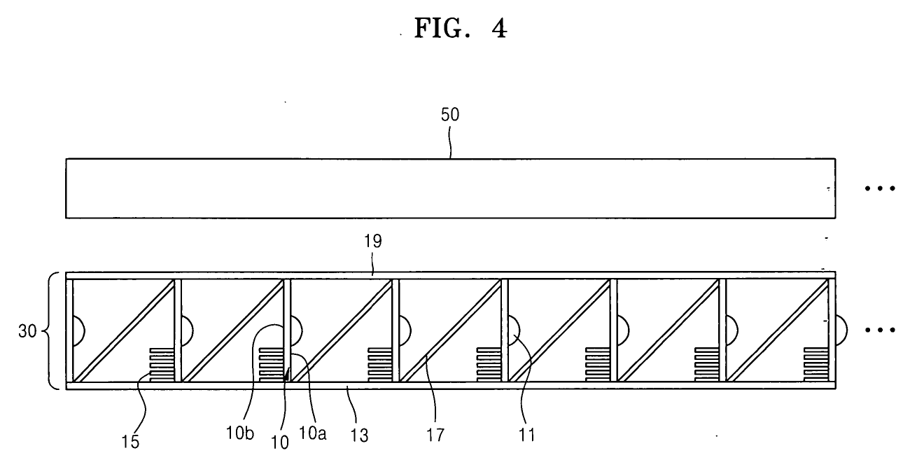

FIG. 4 is a schematic view of an LCD provided with a backlight unit consistent with the present invention.

Referring to FIG. 4, the LCD includes a liquid crystal panel 50 and a backlight unit 30 disposed at a rear of the LCD 50 to irradiate light toward the liquid crystal panel 50.

As is well known to those skilled in the art, the liquid crystal panel 50 allows light linearly polarized in one direction to be incident into a liquid crystal layer of the liquid crystal panel 50, and the direction of liquid crystal director to be changed by an electric field operation, thereby changing polarization of light passing through the liquid crystal layer to display image information. The liquid crystal panel 50 can include all kinds of liquid crystal panels. Since the various structures for the liquid crystal panel 50 are well known to those skilled in the art, their detailed description and illustration will be omitted.

The sequential division lighting operation of the backlight unit according to the present invention will now be described in more detail.

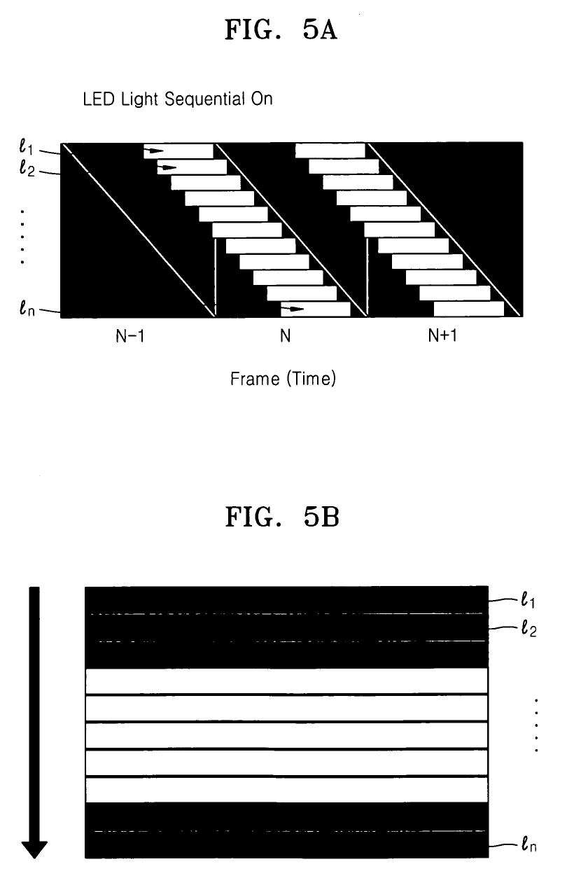

FIG. 5A is a schematic view exemplarily showing a division lighting operation method of light sources 11 in a backlight unit consistent with the present invention, and FIG. 5B is a schematic view exemplarily showing a division lighting state of light sources 11 in a backlight unit consistent with the present invention.

In FIG. 5A, a horizontal axis represents a picture frame, i.e., time, and a vertical axis represents each of division areas (l₁, . . . lₙ) of the backlight unit. Typically, an image of one frame in an LCD TV is sequentially scanned from an upper screen of the LCD TV to a lower screen and an image of next frame starts to be scanned from the upper screen before the lower screen of the previous frame is completely scanned. In the case of the conventional backlight unit using the CCFL, since the entire area of the liquid crystal panel is lighted regardless of the scanning sequence, it fails to effectively remove the motion blur phenomenon. However, in the present invention, since the respective division areas are sequentially lighted at a predetermined time interval for each division area in synchronization with the scanning time of the liquid crystal panel, the motion blur can be effectively removed.

That is, as shown in FIG. 5A, in the moment that N-th frame image on an upper screen of the liquid crystal panel is scanned, the light sources of the 1^{st} division area (l₁) are lighted. After a predetermined time delay depending on the scanning time of the liquid crystal panel, the light sources of 2^{nd} division area (l₂) are lighted. In this way, the light sources are sequentially lighted until the n-th division area (lₙ), so that the lighting of the backlight unit for the N-th frame image is completed. At this time, the light sources of each division area are again not lighted after a constant time elapse, and are then again lighted for a next frame image. In other words, it is controlled that the light sources of the respective division areas repeat lighting and blackout or non-lighting at a predetermined period and the light sources of any division area are lighted after a predetermined time delay since the light sources of a previous division area are lighted. The lighting and blackout period of the respective division areas and the lighting delay time between adjacent division areas are determined depending on a vertical scanning frequency of the liquid crystal panel and the number of the division areas.

Thus, according to the present invention, since the light sources 11 that belong to the respective division areas are sequentially lighted at a predetermined period, the backlight unit at an arbitrary time is not entirely lighted but is partly lighted as shown in FIG. 5B.

Meanwhile, since it is required that the backlight unit be partly lighted at a specific time, it is necessary to prevent the light emitted from a lighting area diverging into a non-lighted area. Since the backlight unit according to the present invention can be divided into plural division lighting areas by the barrier rib structure, light emitted from one division lighting area is prevented from being diffused into an adjacent division lighting area.

The aforementioned backlight unit consistent with the present invention can be used as a backlight unit for an LCD operating in 60 Hz, for example, an LCD TV, and can be sequentially lighted in the N-number of division areas in synchronization with the scanning time of the screen.

Since the backlight unit consistent with the present invention has an installation structure of the heat radiation device inside, it is possible to decrease the overall thickness of the system. Also, since the backlight unit uses the light sources that can be instantly lighted and disposed on the one sidewall surface of each of the barrier ribs for forming plural division areas, light leakage to an adjacent division area as the light sources are sequentially lighted in a group of the division areas in synchronization with the scanning time of the screen can be prevented.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A backlight unit comprising:
a plurality of division areas;
a light source which is operative to be lighted and is disposed on one sidewall surface of at least one barrier rib defining the plurality of division areas; and
a heat radiation device disposed on an opposite wall surface of the at least one barrier rib to the one sidewall surface,
wherein each of the plurality of division areas is constructed to bi-divide light reflection and heat radiation.

2. The backlight unit of claim 1, wherein the heat radiation device comprises at least one heat radiation fin.

3. The backlight unit of claim 1, wherein the light source comprises one of a light emitting diode (LED) and an organic light emitting diode (OLED).

4. The backlight unit of claim 1, wherein the at least one barrier rib is provided with a metal core printed circuit board (MCPCB).

5. A backlight unit comprising:
a plurality of barrier ribs spaced apart from one another to form a plurality of division areas;
a plurality of light sources which are disposed on one sidewall surface of each of the plurality of barrier ribs and are operative to be instantly lighted;
a heat radiation device disposed at a rear of each of the plurality of barrier ribs to radiate heat generated from the plurality of light sources disposed on the one sidewall surfaces of the plurality of barrier ribs;
a reflection member disposed inclined to each of the plurality of barrier ribs to reflect light emitting from the plurality of light sources; and
a diffusion plate disposed over the plurality of barrier ribs to diffuse and transmit incident light.

6. The backlight unit of claim 5, wherein the heat radiation device comprises at least one heat radiation fin.

7. The backlight unit of claim 5, wherein the light source comprises one of a light emitting diode (LED) and an organic light emitting diode (OLED).

8. The backlight unit of claim 5, wherein the plurality of light sources disposed on each of the plurality of barrier ribs are arranged so as to form a line.

9. The backlight unit of claim 5, wherein the plurality of light sources disposed on each of the plurality of barrier ribs comprise three kinds of light sources respectively emitting red, green and blue lights and mixed with one another so as to emit white light, or each of the plurality of light sources is a multi-chip light source emitting red, green and blue lights.

10. The backlight unit of claim 5, wherein the plurality of light sources belonging to the respective plurality of division areas are sequentially lighted at a predetermined time interval.

11. The backlight unit of claim 5, wherein each of the plurality of barrier ribs is provided with a metal core printed circuit board (MCPCB).

12. A liquid crystal display (LCD) comprising a liquid crystal panel and a backlight unit disposed at a rear of the liquid crystal panel to irradiate light toward the liquid crystal panel,
wherein the backlight unit comprises:
a plurality of division areas;
a light source which is operative to be lighted and is disposed on one sidewall surface of at least one barrier rib defining the plurality of division areas; and
a heat radiation device disposed on an opposite wall surface of the at least one barrier rib to the one sidewall surface,
wherein each of the plurality of division areas is constructed to bi-divide light reflection and heat radiation.

13. The LCD of claim 12, wherein the heat radiation device comprises at least one heat radiation fin.

14. The LCD of claim 12, wherein the light source comprises one of a light emitting diode (LED) and an organic light emitting diode (OLED).

15. The LCD of claim 12, wherein the barrier rib is provided with a metal core printed circuit board (MCPCB).

16. The LCD of claim 12, wherein the plurality of light sources belonging to the respective plurality of division areas are sequentially lighted in synchronization with a screen scanning time of the liquid crystal panel.

17. A liquid crystal display (LCD) comprising a liquid crystal panel and a backlight unit disposed at a rear of the liquid crystal panel to irradiate light toward the liquid crystal panel,
wherein the backlight unit comprises:
a plurality of barrier ribs spaced apart from one another to form a plurality of division areas;
a plurality of light sources which are disposed on one sidewall surface of each of the plurality of barrier ribs and are operative to be instantly lighted;
a heat radiation device disposed at a rear of each of the plurality of barrier ribs to radiate heat generated from the plurality of light sources disposed on the one sidewall surfaces of the plurality of barrier ribs;
a reflection member disposed inclined to each of the plurality of barrier ribs to reflect light emitting from the plurality of light sources; and
a diffusion plate disposed over the plurality of barrier ribs to diffuse and transmit incident light.

18. The LCD of claim 17, wherein the heat radiation device comprises at least one heat radiation fin.

19. The LCD of claim 17, wherein the light source is comprises one of a light emitting diode (LED) and an organic light emitting diode (OLED).

20. The LCD of claim 17, wherein the plurality of light sources disposed on the plurality of barrier ribs are arranged so as to form a line.

21. The LCD of claim 17, wherein the plurality of light sources disposed on the plurality of barrier ribs comprise three kinds of light sources respectively emitting red, green and blue lights and mixed with one another so as to emit white light, or each of the plurality of light sources is a multi-chip light source emitting red, green and blue lights.

22. The LCD of claim 17, wherein the plurality of light sources belonging to the respective plurality of division areas are sequentially lighted at a predetermined time interval.

23. The LCD of claim 17, wherein the plurality of light sources belonging to the respective plurality of division areas are sequentially lighted in synchronization with a screen scanning time of the liquid crystal panel.

24. The LCD of claim 17, wherein each of the plurality of barrier ribs is provided with a metal core printed circuit board (MCPCB).
